(19) United States
(12) Patent Application Publication
(10) Pub. No.: US 2010/0107497 A1
(43) Pub. Date: May 6, 2010

(54) FULL VIEW STORM DOOR

(75) Inventors: Michael J. Hulst, Holland, MI (US); Gary DeGroff, Holland, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: MAGNA MIRRORS OF AMERICA, INC., Holland, MI (US)

(21) Appl. No.: 12/612,723

(22) Filed: Nov. 5, 2009

Related U.S. Application Data
(60) Provisional application No. 61/111,402, filed on Nov. 5, 2008.

(51) Int. Cl. E06B 3/56; E05D 15/40; E05F 1/12

(52) U.S. Cl. 49/162; 52/784.1; 49/501; 52/309.1; 52/656.4

(57) ABSTRACT

A door assembly for use in a building includes a glass door panel having an outer surface and an inner surface and a perimeter region. The door assembly includes at least one metallic hardware element bonded via a layer of cured adhesive to the inner surface of the door panel and at least partially along the perimeter region of the door panel. The layer of cured adhesive bonds the at least one metallic hardware element to the inner surface of the door panel without exposure of the metallic hardware element on the outer surface of the door panel. The door assembly may include a perimeter frame portion bonded to the inner surface of the door panel via another layer of cured adhesive. At least a portion of a door handle assembly may protrude through an aperture formed in the glass door panel.

### CROSS REFERENCE TO RELATED APPLICATION

The present application claims the benefit of U.S. provisional application Ser. No. 61/111,402, filed Nov. 5, 2008, which is hereby incorporated herein by reference in its entirety.

### FIELD OF THE INVENTION

The present invention relates to glass paneled doors, such as storm doors for houses or buildings.

### BACKGROUND OF THE INVENTION

Storm doors typically include a frame that supports the glass panel and that encompasses the perimeter edge and overlaps both the interior and exterior surfaces of the door panel around the perimeter edge. The hinge or hinges and any closure bracket or device are attached to or incorporated in or at the frame. Likewise, the door handle assembly is partially received in the frame and the shaft of the door handle assembly extends through the frame outboard of the perimeter edge of the glass panel.

### SUMMARY OF THE INVENTION

The present invention provides a door assembly that includes a glass panel and at least one metallic hardware element single-sided bonded to the glass panel so that the hardware element is not exposed on an opposite surface of the glass panel. A perimeter frame may also be single-sided bonded to the glass panel so that the frame is not exposed on an opposite surface of the glass panel. For example, the hardware element and/or the frame may be bonded to an interior surface of the glass panel so as to not be exposed at the exterior surface of the glass panel when the door assembly is normally mounted at a house or building. The door assembly may include a door handle and latch mechanism at the frame, and the mechanism may extend through the glass panel, such as through a hole or aperture formed in the glass panel. The hardware element or elements of the door assembly may include one or more hinge elements or closure brackets or mounting brackets, such as metallic mounting brackets, bonded to the glass panel (such as at or in or partially in the perimeter frame) for structural rigidity of the door assembly, such as at locations where door closers or the like are mounted or attached to the door assembly. The glass panel may include an opaque layer around its perimeter (such as a frit layer or the like) and along the bonded region of the hardware elements and/or perimeter frame to provide an enhanced appearance to the door assembly.

According to an aspect of the present invention, a door assembly for use in a building includes a door panel comprising a glass material, and a perimeter frame portion. The door panel has an outer surface and an inner surface and a perimeter region. The perimeter frame portion is bonded via a layer of cured adhesive to the inner surface of the door panel and along the perimeter region of the door panel. The layer of cured adhesive bonds the perimeter frame portion to the inner surface of the glass door panel without exposure of the bonded perimeter frame portion on the outer surface of the glass door panel.

The door assembly may include at least one metallic hardware mounting element adhesively bonded to the glass panel via another layer of adhesive. The perimeter frame portion may substantially or at least partially encompass or encase or surround the hardware mounting element. A hardware element, such as a hinge element or closure bracket or the like, may attach to the perimeter frame portion and the hardware mounting element for mounting the door assembly at the building or door frame or the like.

According to another aspect of the present invention, a door assembly for use in a building includes a door panel comprising a glass material and having an outer surface and an inner surface and a perimeter region. At least one metallic hardware element is bonded to the inner surface of the glass door panel via a layer of cured adhesive. The hardware element is disposed at or near the perimeter region of the door panel and is configured for mounting to a support element at the building. For example, the hardware element or elements may include a hinge attachment element for attaching to a hinge element at the support element at the building and/or a closure bracket for a door closing device (such as a conventional door closing device, such as a spring or biased chain or a pneumatic or gas device or spring or the like) to attach to the door so as to bias or urge the door towards a closed position or orientation relative to the building.

Therefore, the present invention provides a substantially transparent glass door panel that has a metallic hardware element and/or a perimeter frame adhesively bonded along its perimeter regions so as to avoid exposure of the perimeter frame at an outer or opposite surface of the glass panel. The door assembly may include metallic or structural brackets or elements adhesively bonded to the surface of the glass panel and at the perimeter frame. The door panel may have an opaque coating or layer, such as a ceramic frit layer or the like, along its perimeter region and in the bonding area along the perimeter region or perimeter frame to conceal the perimeter frame and/or hardware element so that it is not readily discernible and viewable through the substantially transparent glass door panel.

These and other objects, advantages, purposes and features of the present invention will become apparent upon review of the following specification in conjunction with the drawings.

### BRIEF DESCRIPTION OF THE DRAWINGS

FIG. 1 is a perspective view of a door assembly in accordance with the present invention;

FIG. 2 is a plan view of the door assembly of FIG. 1, as viewed from outside the structure at which the door assembly is mounted;

FIG. 3 is a plan view of the door assembly of FIG. 1, as viewed from inside the structure at which the door assembly is mounted;

FIG. 4A is a sectional view of the door assembly taken along the line A-A in FIG. 3;

FIG. 4B is a sectional view of the door assembly taken along the line B-B in FIG. 3;

FIG. 4C is a sectional view of the door assembly taken along the line C-C in FIG. 3;

FIG. 4D is a sectional view of the door assembly taken along the line D-D in FIG. 3;

FIG. 4E is a sectional view of the door assembly taken along the line E-E in FIG. 3;

FIG. 5 is a plan view of the glass panel of the door assembly of the present invention;

FIG. 6 is a plan view of the perimeter frame of the door assembly of the present invention;

FIG. 7A is a sectional view of the perimeter frame taken along the line A-A in FIG. 6;

FIG. 7B is a sectional view of the perimeter frame taken along the line B-B in FIG. 6;

FIG. 7C is a sectional view of the perimeter frame taken along the line C-C in FIG. 6;

FIG. 7D is a sectional view of the perimeter frame taken along the line D-D in FIG. 6;

FIG. 8A is a plan view of a hinge bracket of the door assembly of the present invention;

FIG. 8B is an end elevation of the hinge bracket of FIG. 8A;

FIG. 8C is a side elevation of the hinge bracket of FIG. 8A;

FIG. 8D is a sectional view of the hinge bracket taken along the line D=D in FIG. 8A;

FIG. 9A is a plan view of a closure bracket of the door assembly of the present invention;

FIG. 9B is an end elevation of the closure bracket of FIG. 9A;

FIG. 9C is a sectional view of the closure bracket taken along the line C-C in FIG. 9A;

FIG. 10 is a plan view of another door assembly in accordance with the present invention;

FIG. 10A is a sectional view of the door assembly taken along the line A-A in FIG. 10;

FIG. 10B is a sectional view of the door assembly taken along the line B-B in FIG. 10;

FIG. 10C is a sectional view of the door assembly taken along the line C-C in FIG. 10;

FIG. 10D is a sectional view of the door assembly taken along the line D-D in FIG. 10;

FIG. 10E is a sectional view of the door assembly taken along the line E-E in FIG. 10;

FIG. 11 is a plan view of another door assembly in accordance with the present invention, with hardware elements bonded to the glass door panel and without a perimeter frame;

FIG. 11A is a sectional view of the door assembly taken along the line A-A in FIG. 11;

FIG. 11B is a sectional view of the door assembly taken along the line B-B in FIG. 11;

FIG. 11C is a sectional view of the door assembly taken along the line C-C in FIG. 11;

FIG. 11D is a sectional view of the door assembly taken along the line D-D in FIG. 11;

FIG. 11E is a sectional view of the door assembly taken along the line E-E in FIG. 11;

FIG. 12A is an enlarged plan view of a plate attachment bracket of the door assembly of FIG. 11;

FIG. 12B is a side elevation of the plate attachment bracket of FIG. 12A;

FIG. 12C is a sectional view of the plate attachment bracket taken along the line C-C in FIG. 12A;

FIG. 13A is an enlarged plan view of a closure bracket of the door assembly of FIG. 11;

FIG. 13B is a side elevation of the closure bracket of FIG. 13A; and

FIG. 13C is a sectional view of the closure bracket taken along the line C-C in FIG. 13A.

### DESCRIPTION OF THE PREFERRED EMBODIMENTS

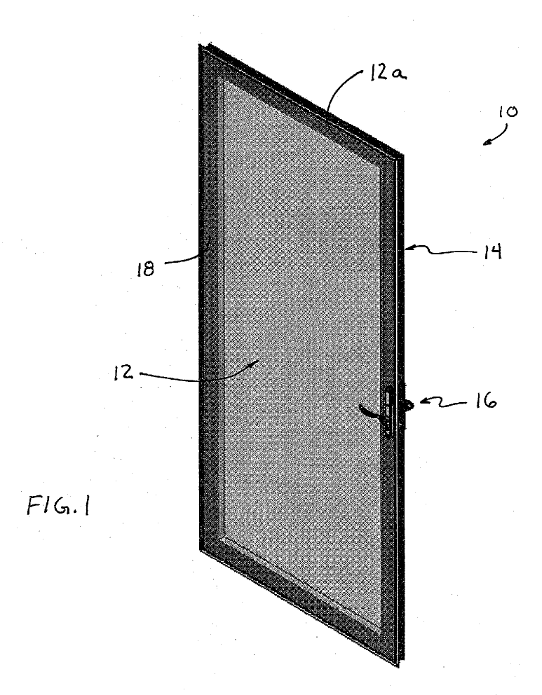

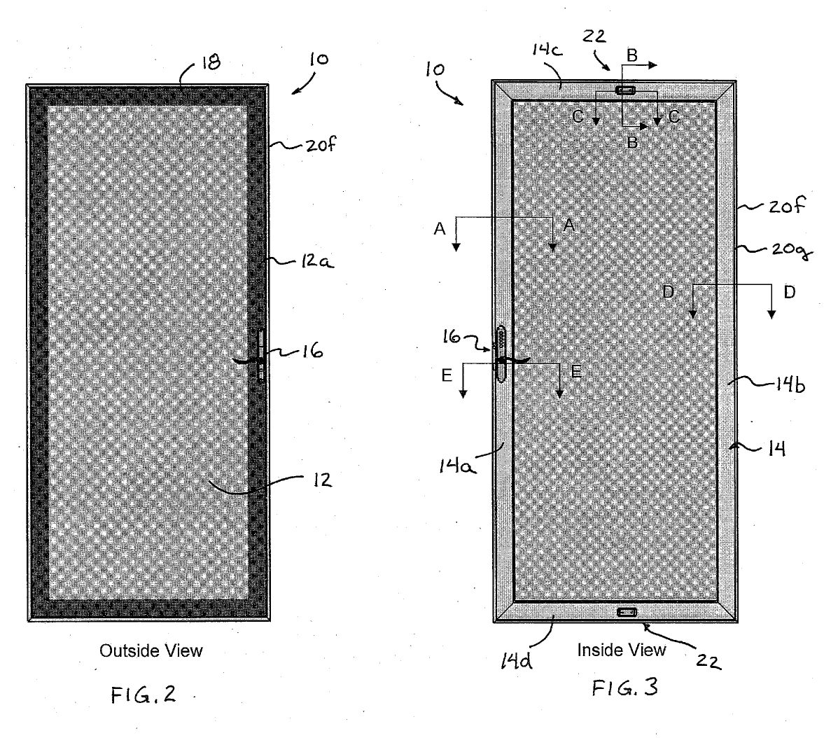

Referring now to the drawings and the illustrative embodiments depicted therein, a door assembly 10 for a building or house or structure includes a substantially transparent door panel 12 that has a perimeter frame portion 14 bonded at least partially along the perimeter regions or edges 12a of door panel 12 (FIGS. 1-3). The perimeter frame 14 is bonded or adhered to a surface of the door panel 12 (such as to an interior surface 12b of the door panel when the door assembly is normally mounted to a structure or building) so that the frame does not extend around the perimeter edge of the door panel to encompass or cover a portion of the opposite surface of the door panel (such as an exterior surface 12c of the door panel when the door assembly is normally mounted to a structure or building). The perimeter frame 14 thus may be single-sided bonded to the interior or inner surface 12b of the door panel 12 without exposure of the bonded perimeter frame on the opposite or exterior or outer surface of the door panel. The mounting hardware of the door assembly may be bonded to the door panel and substantially contained within and concealed by the frame portion, as discussed below. Thus, when viewed from the outside of the door, the only material visible other than door panel is a door handle 16 and the bonded surface of the frame 14 that extends around the entire perimeter of the door panel. The mounting hardware may be bonded to the door panel and the frame portion may be assembled to the hardware bonded glass door panel to create the finished product.

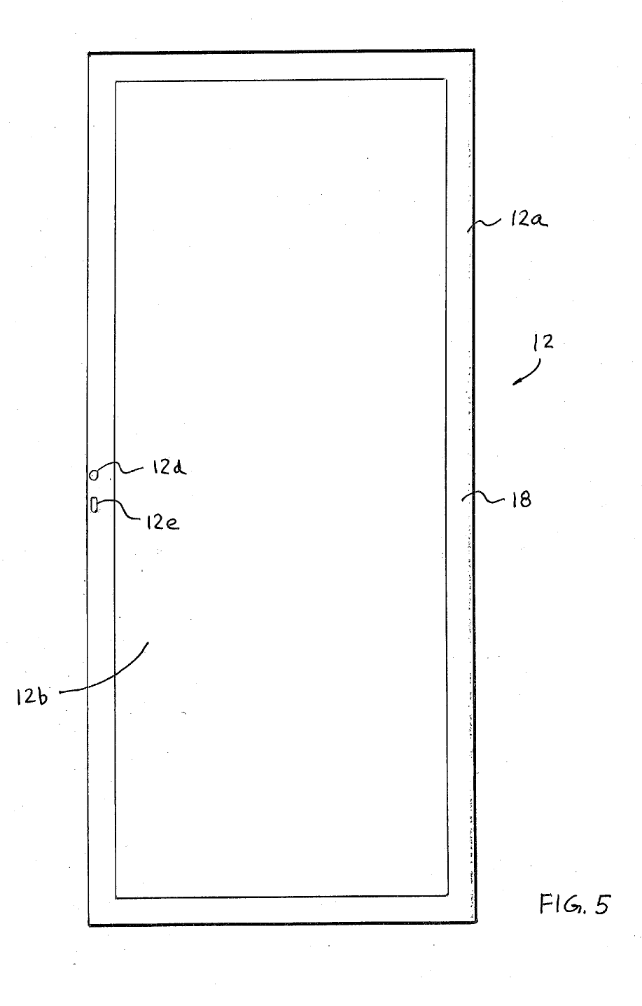

Door panel 12 may comprise a glass panel, and preferably a substantially transparent strengthened glass panel, such as a tempered or toughened glass panel, suitable for use as a door for a house or building or other structure or environment. The glass panel may be cut to the desired size and shape for the door. As shown in FIG. 5, glass door panel 12 may include an aperture or hole 12d formed therethrough for receiving a shaft of a door handle assembly 16, and may include a second aperture or hole 12e for receiving a lock cylinder or other latch mechanism of the door handle assembly, as discussed below.

Optionally, and as can be seen in FIGS. 1, 2 and 5, the perimeter regions of the interior surface of the door panel 12 may have a non-transparent or opaque coating or frit layer 18 or paint or ink or the like disposed thereon, so as to substantially conceal the perimeter frame 14 and limit viewing of the perimeter frame and adhesive through the door panel from the exterior side of the door panel. Optionally, the frit or paint or ink layer or coating may be disposed or screened onto the surface 12b of the door panel after forming the glass door panel. In applications where an opaque or non-transparent frit layer or other pattern or the like may be disposed at the surface of the door panel, the adhesive may comprise a substantially non-transparent adhesive.

Optionally, the frit layer may comprise a ceramic fit layer and may function to facilitate adhering or bonding of the perimeter frame to the door panel. The fit layer may be substantially opaque, and thus may improve the overall appearance of the door assembly, since the bonding surfaces are not readily discernible or viewable through the door panel and the frit layer. Examples of such fit layers are described in U.S. Pat. Nos. 7,360,338; 7,332,225; 6,871,450; 6,846,039; 6,319,344; 6,298,606; 6,128,860; 6,068,719; 5,966,874; 5,853,8954; 5,704,173; and 5,551,197, which are hereby incorporated herein by reference in their entireties. The fit layer may comprise a black or substantially opaque layer, or may comprise a white layer or other color as desired, such as to match a color scheme of the perimeter frame or door frame or building at which the door assembly is mounted. The frit layer may be disposed onto the surface of the door panel in any desired pattern, such as stripes, dots, wave pattern or the like, to provide the desired appearance to the door, depending on the particular application of the door assembly.

Optionally, the fit layer 18 may be disposed or deposited on and bonded to the surface of door panel 12 as an opaque frit layer or coating covering and concealing a region of the surface from a peripheral edge region 12a of the door panel inward a desired or appropriate amount, so as to establish a border coating around the perimeter of the door panel. Door panel 12, which may be initially in an unstrengthened or untempered condition after cutting and sizing to its desired shape, can be painted, such as by screen coating or other techniques, with a coating of ceramic paint on its inner surface and along the perimeter regions thereof. Thereafter, door panel 12 may be heated, followed by strengthening, such as tempering, to strengthen the glass. Such heating and tempering operations cause the ceramic paint to become fused to the surface of the door panel. Thus, although starting as a layer of paint containing ceramic particles and pigment, the coating ends up as a thin frit layer of ceramic material, which is fused to the surface of the glass door panel. Since the ceramic frit coating includes a pigment of a desired color, the layer results in a permanent surface coloration of the glass door panel. However, the perimeter frame may optionally be bonded to the surface of the door panel without any frit layer on the door surface, depending on the particular application and desired appearance of the door assembly.

Perimeter frame 14 comprises elongated side portions 14a, 14b and an upper portion 14c and a lower portion 14d joined together or abutting one another at the corners of the door panel and adhered or bonded to the interior surface of the door panel 12 via a suitable adhesive. In the illustrated embodiment, perimeter frame portions 14a-d comprise extruded frame portions, such as plastic or polymeric frame portions formed by extruding the polymeric material to form elongated portions that are cut to the desired or appropriate length and formed to have their ends abut the respective ends of the adjacent frame portions (such as by mitering the ends to a 45 degree angle or the like). The mitered corners may be welded or heat staked together to join the frame portions at the corners. Optionally, the frame portion may comprise any suitable material, such as a metallic material (such as aluminum or other suitable material) or a plastic or polymeric material, while remaining within the spirit and scope of the present invention.

In the illustrated embodiment, each frame portion 14a-d of perimeter frame 14 may comprise a bonding surface or wall 20a and an opposite surface or wall 20b with one or more ribs or structural webs or elements 20c disposed between the surfaces or walls 20a, 20b. Perimeter frame 14 includes side walls 20d, 20e at opposite sides of the frame portion, with the outer side wall 20e having a trim element or strip 20f that is disposed along the perimeter edge 12f of door panel 12 to provide a finished perimeter trim element around the perimeter edge of the door panel. Trim element 20f supports a flexible sealing element or bead or strip 20g for engaging the door frame of the building to which the door assembly is mounted so as to seal the door around its perimeter edges relative to the building. In the illustrated embodiment, bonding wall 20a includes a channel 20g that is spaced from the surface 12b to which the frame portion is bonded by a pair of legs or extensions 20h of bonding wall 20a, so as to provide a channel in which the adhesive layer is disposed, as discussed below.

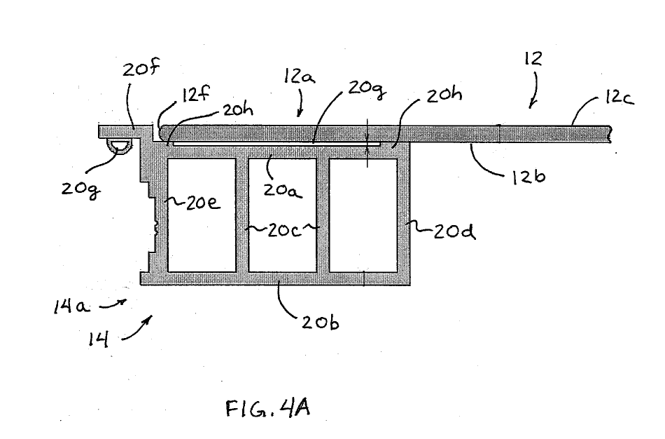

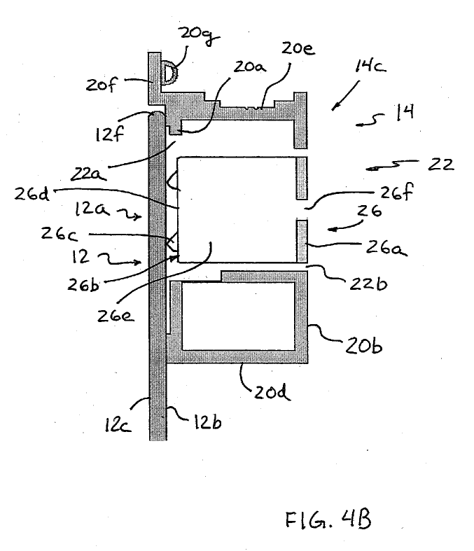

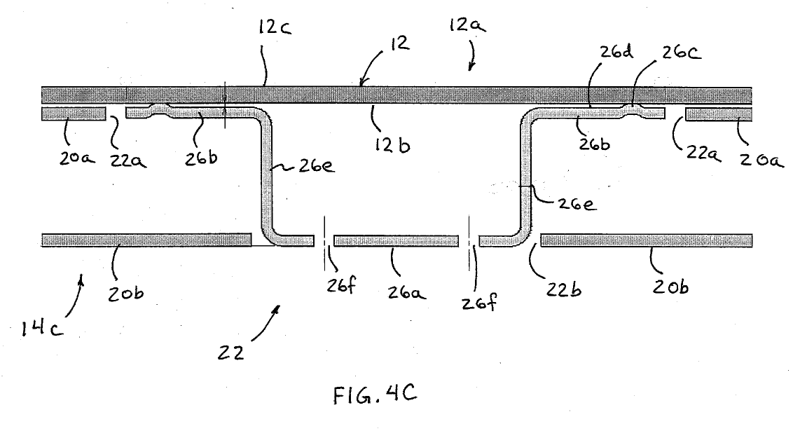

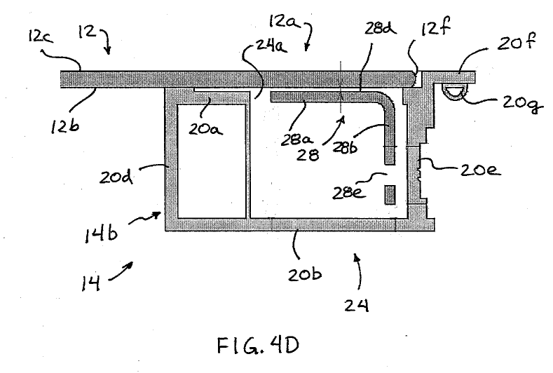

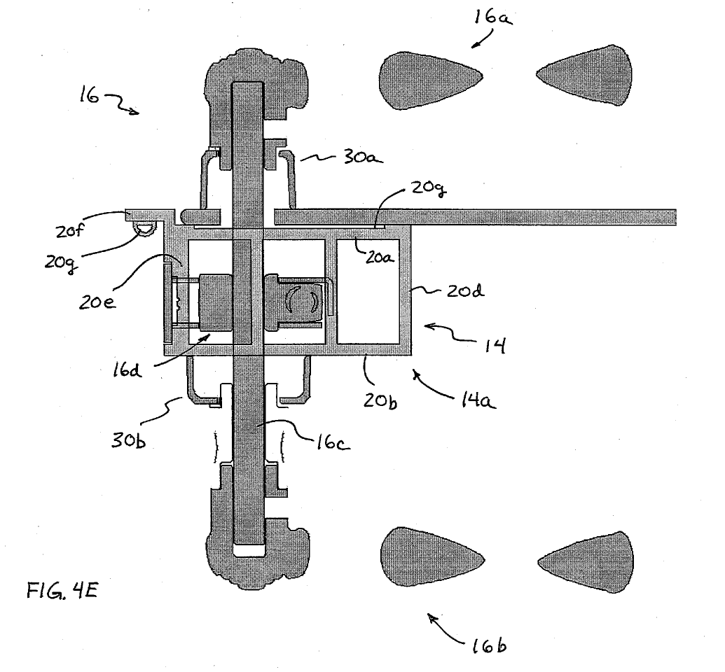

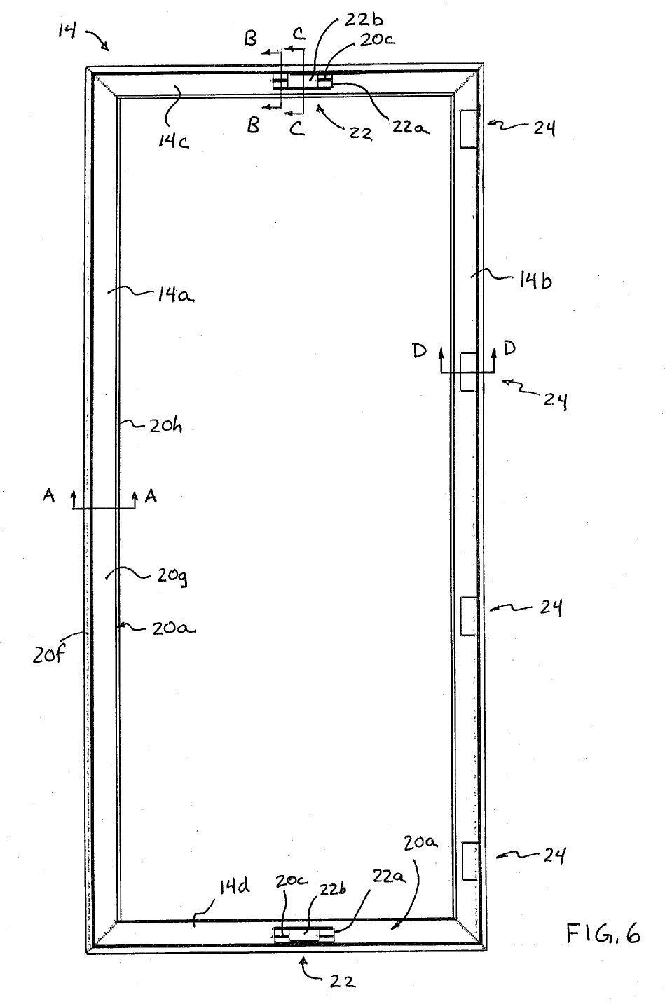

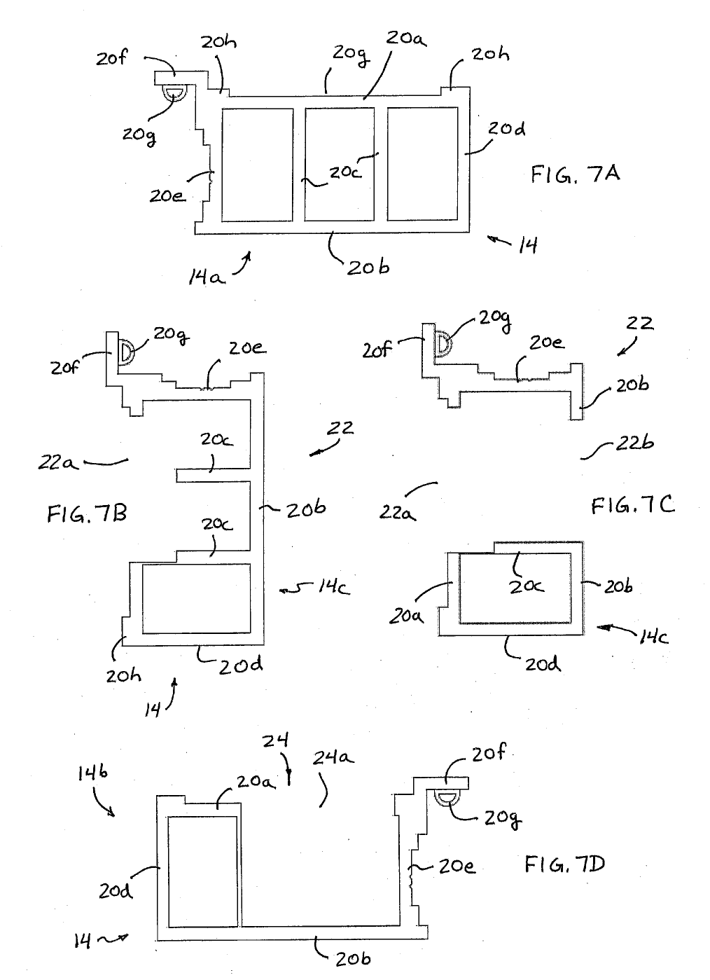

In the illustrated embodiment, the frame portions are formed as described above and as shown in FIGS. 4A and 7A along a substantial portion of their lengths. Other forms may be established, such as cutaways and apertures formed through the frame portions at particular locations along the frame portions to provide clearance for or mounting of various closure mounting brackets and/or door handles and/or hinge mounting brackets or the like. For example, and as shown in FIGS. 3 and 6, perimeter frame 14 may include a closure bracket mounting area 22 at the upper frame portion 14c and/or lower frame portion 14d, and one or more hinge mounting areas 24 at the side frame portion 14b, as discussed below.

As shown in FIGS. 4B, 7B and 7C, closure bracket mounting area 22 of frame portion 14c includes an opening or aperture 22a formed through the bonding wall 20a and an opening or aperture 22b (or apertures) formed through opposite or outer wall 20b (with the webs 20c removed or partially removed at and along the openings) to receive a closure bracket 26 thereat.

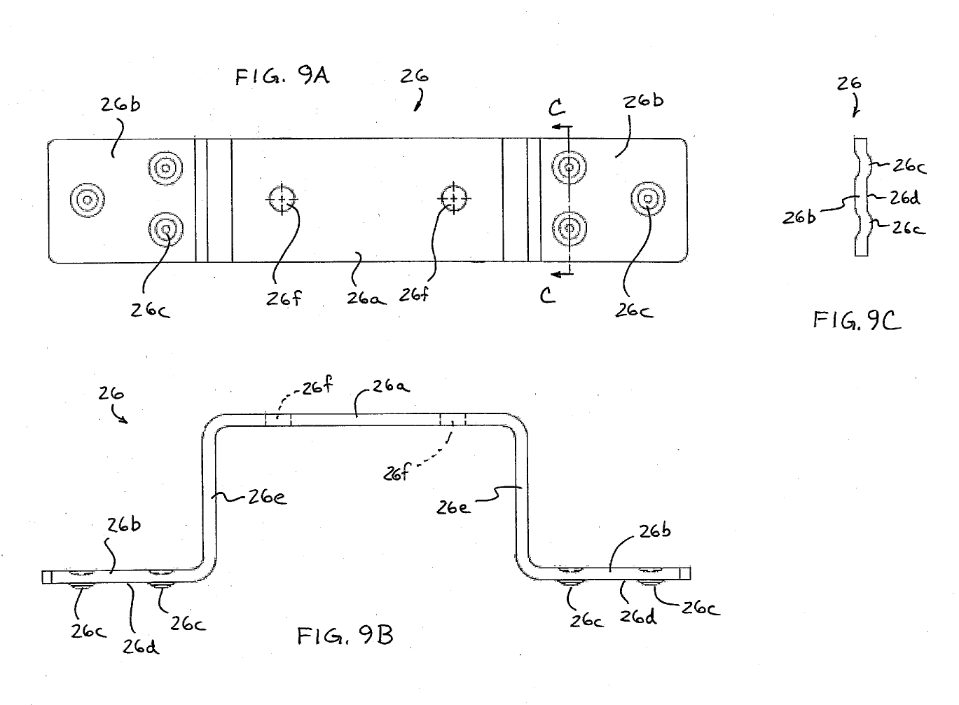

The closure bracket 26 may be bonded to the door panel via a suitable adhesive, and may be received in frame portion 14c at apertures 22a, 22b. Closure bracket 26 (FIGS. 3, 4B, 4C and 9A-C) may comprise a metallic bracket or structure (such as steel, such as 1008/1010 cold rolled steel, and optionally such as E-coated steel that is E-coated with a cathodic electro deposition epoxy resin zinc phosphate or the like), and provides a mounting location or attachment location for a door closing device'(such as a conventional door closing device, such as a spring or biased chain or a pneumatic or gas device or spring or the like) to attach to the door (and to attach at its other end to the building or structure) to limit opening of the door and/or to bias or urge the door towards its closed position or orientation. In the illustrated embodiment, closure bracket 26 comprises a metallic bracket having an attaching portion or flange 26a and a pair of mounting flanges 26b. The mounting flanges 26b are adhered to the glass panel surface 12b and optionally may have a plurality of projections or protrusions or standoffs 26c (such as three or more non-linearly arranged standoffs or embossments disposed inboard of the perimeter edges of the mounting flanges) protruding therefrom for spacing the bonding surface 26d of the mounting flanges 26b for establishing the desired or appropriate bond line thickness of the layer of adhesive that bonds the closure bracket to the door panel 12. The attaching flange 26a of closure bracket 26 is spaced outwardly from mounting flanges 26b by a pair of legs or stanchions 26e of closure bracket 26 so that the attaching flange 26a is generally flush with the outer wall 20b of frame portion 14c, Attaching flange 26a includes one or more apertures 26f established therethrough for receiving respective fasteners (such as screws or the like) to mount or attach or fasten a door closing device to the door assembly.

The closure bracket 26 thus is received in frame portion 14c with its attaching flange 26a exposed for attaching the closing device to the door. The mounting flanges 26b are bonded to the glass door panel within frame portion 14c and at a closure bracket mounting area of frame portion 14c. The webs 20c of frame portion 14c may be fully removed at a central region of the closure bracket mounting area 22 of frame portion 14c, and may be partially removed at the side regions of the closure bracket mounting area. For example, and as can be seen with reference to FIGS. 4C, 6, 7B and 7C, the aperture 22a may be larger than aperture 22b and the webs may be removed at the outer regions of the larger aperture to provide space for the mounting flanges of the closure bracket 26 when the closure bracket is received within frame portion 14c. Optionally, and as shown in FIG. 3, both the upper and lower frame portions 14c, 14d may include closure bracket mounting areas for mounting upper and/or lower door closing devices to the door. Optionally, the frame portions may be formed with their outer surfaces 20b continuous (i.e., without aperture 22b formed therethrough), whereby a user may cut the desired aperture 22b to expose the closure bracket mounting area 22 and closure bracket 26 at the desired one or both of the frame portions 14c, 14d, depending on the particular application of the door assembly.

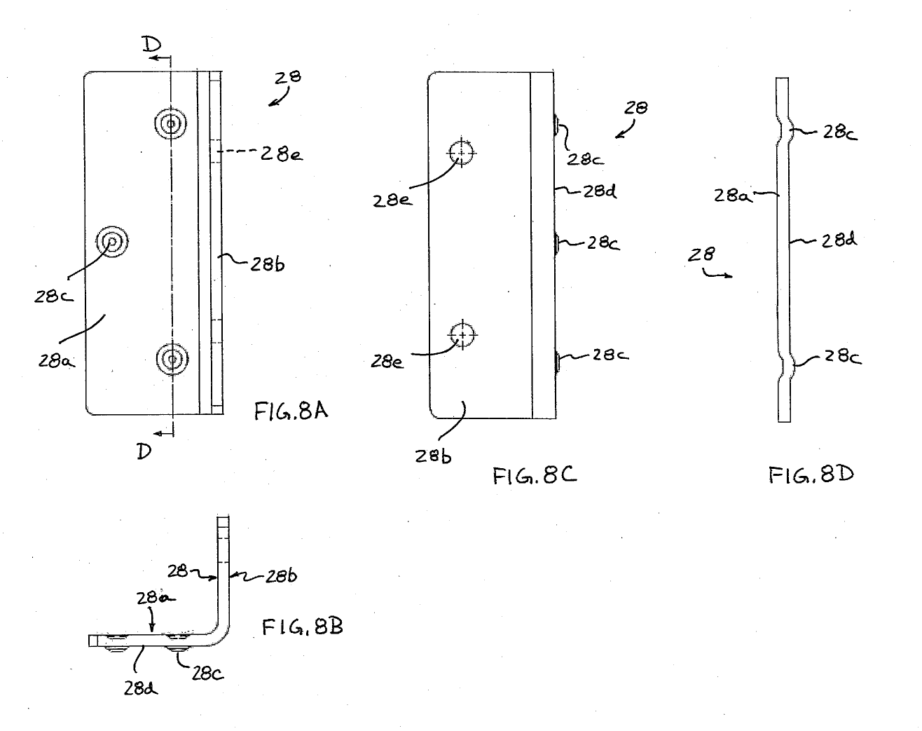

Also, frame portion 14b may include one or more hinge mounting areas 24 that have hinge brackets 28 mounted thereat. For example, the hinge mounting area 24 of frame portion 14b may have an aperture 24a established through bonding wall 20a of frame portion 14b. As shown in FIG. 4D, a hinge bracket 28 is disposed within frame portion 14b and is bonded to glass door panel 12 at aperture 24a. Hinge bracket 28 (FIGS. 4D and 8A-D) may comprise a generally L-shaped metallic bracket (such as steel, such as 1008/1010 cold rolled steel, and optionally such as E-coated steel that is E-coated with a cathodic electro deposition epoxy resin zinc phosphate or the like), that includes a mounting flange 28a bonded to the door panel 12 and a hinge attaching flange 28b extending along outer side wall 20e of frame portion 14b. Mounting flange 28a may be adhered to the glass panel surface 12b and may have a plurality of projections or protrusions or standoffs 28c (such as three or more non-linearly arranged standoffs or embossments disposed inboard of the perimeter edges of the mounting flanges) protruding therefrom for spacing the bonding surface 28d of the mounting flange 28a for establishing the desired or appropriate bond line thickness of the layer of adhesive that bonds the hinge bracket to the door panel 12. Hinge attaching flange 28b may include one or more apertures 28e for receiving a fastener, such as a screw or the like, for attaching a hinge element to the hinge attaching flange. The fastener may be threaded or screwed through the outer side wall 20e of frame portion 14b or an aperture or hole (or holes) may be established through the outer side wall 20e that generally aligns with the aperture or apertures of the hinge bracket 28 or a hole or aperture (or apertures) may be established through the outer side wall 20e and through the hinge bracket 28 at the mounting location or building or structure to provide generally aligned holes for aligning with and attaching to the hinge or hinge element at the mounting location or installation site of the door assembly.

Door assembly 10 also includes handle assembly 16, which includes handle portions 16a, 16b and a shaft 16c connecting handle portions 16a, 16b. As can be seen in FIG. 4E, shaft 16c extends through frame portion 14a and through aperture 12d of door panel 12. As also shown in FIG. 4E, a mounting element or trim element 30a may be disposed at outer surface 12c of door panel 12, while an inner mounting element or trim element 30b may be disposed at opposite or inner wall 20b of frame portion 14a, with shaft 16c being rotatably or pivotally mounted to or received through trim elements 30a, 30b, and with handle portions 16a, 16b being attached to shaft 16c outboard of trim elements 30a, 30b. Handle portion 16 also includes a latch mechanism 16d that is actuatable via rotation of shaft 16c to engage and release a corresponding latch element at the door frame of the building or structure, such as in a manner known in the art. As shown in FIG. 4E, frame portion 14a may be modified at the door handle mounting area to accommodate the shaft 16c and latch mechanism 16d within frame portion 14a (such as by removing the outer web 20c at the area that corresponds to aperture 12d to provide clearance for shaft 16c and by providing an aperture through outer side wall 20e of frame portion 14a for latch mechanism 16d). Optionally, a locking device (such as a dead-bolt type locking device or the like) may be provided, with the shaft of the locking device extending through a second aperture or hole 12e of door panel 12.

Optionally, the aperture 12d through door panel 12 may be generally centered vertically along the side perimeter region 12a, whereby the door assembly may be reversible or universal, and may be readily flipped over to accommodate either a right hinge configuration or a left hinge configuration, depending on the particular application of the door assembly. The door handles 16a, 16b and shaft 16c may then be installed in accordance with the desired or appropriate right or left hinge configuration. Optionally, the aperture through the door panel may be established at the installation of the door assembly and after it is determined which hinge configuration is appropriate for the particular application of the door assembly.

Thus, door assembly 10 may include metallic hinge brackets 28 and metallic closure brackets 26 bonded to the glass surface 12b of glass door panel 12 and plastic or polymeric frame portions 14a-d bonded to the glass surface 12b of glass door panel 12. The metallic hardware may be bonded to the glass surface via any suitable adhesive or bonding means, such as via curing of a bonding or adhesive material and utilizing bonding processes of the types described in U.S. Pat. Nos. 7,360,338; 7,332,225; 6,871,450; 6,846,039; 6,319,344; 6,298,606; 6,128,860; 6,068,719; 5,966,874; 5,853,895; 5,704,173; and/or 5,551,197, which are hereby incorporated herein by reference in their entireties. Optionally, the metallic hardware may be bonded to the glass surface via a two component urethane adhesive, such as by utilizing aspects of the bonding processes described in U.S. Pat. Nos. 7,332,225; 6,846,039; 6,319,344; 6,068,719; and 5,853,895, which are hereby incorporated herein by reference in their entireties (such as a two component urethane adhesive having an isocyanate component and a polyol component with the polyol component including at least one plural amine compound). Optionally, an adhesion promoting primer may be disposed at the metallic hardware and/or the glass surface prior to joining the hardware to the glass surface, such as by utilizing aspects of the bonding processes described in the above incorporated U.S. patents.

Likewise, the plastic or polymeric perimeter frame 14 may be single-sided bonded to the glass surface 12b of door panel 12 via any suitable adhesive, such as via curing of a bonding or adhesive material and utilizing bonding processes of the types described in U.S. Pat. Nos. 7,360,338; 7,332,225; 6,871,450; 6,846,039; 6,319,344; 6,298,606; 6,128,860; 6,068,719; 5,966,874; 5,853,895; 5,704,173; and/or 5,551,197, which are hereby incorporated herein by reference in their entireties. Optionally, the plastic frame may be bonded to the glass surface via a one component urethane adhesive, such as by utilizing aspects of the bonding processes described in U.S. Pat. Nos. 7,360,338; 6,871,450; 6,298,606; 6,128,860; 5,966,874; 5,704,173; and/or 5,551,197, which are hereby incorporated herein by reference in their entireties. Optionally, an adhesion promoting primer may be disposed at the frame portion and/or the glass surface prior to joining the frame portion to the glass surface, such as by utilizing aspects of the bonding processes described in the above incorporated U.S. patents.

Optionally, and such as shown in the illustrated embodiment, the door panel may include a fit layer 18 along the inner surface and along the perimeter regions of the door panel to substantially conceal the bonded hardware and frame portions along the perimeter regions so that the hardware and frame portions are not readily viewable through the door panel from outside the door. Optionally, however, the door panel may not include a fit layer, and the hardware and frame portion may be bonded directly to the inner surface of the door panel. Optionally, the hardware and frame portion may be bonded to the door panel via other suitable adhesives, such as via a UV cured adhesive or the other type of cured adhesive or bonding adhesive or the like, while remaining within the spirit and scope of the present invention. Optionally, the bonding adhesive may be selected from a number of adhesive types or classes including moisture-activated urethanes, such as described in U.S. Pat. No. 3,707,521, which is hereby incorporated herein by reference in its entirety, moisture-activated silicones, moisture-curable activated urethanes, chemically-activated adhesives, and thermally-activated adhesives, and/or the like. Other adhesives, such as aerobically-cured, anaerobically-cured, and radiation-cured adhesives can also be used, without affecting the scope of the present invention. When cured, the bond-line thickness may be in the range of about 1 micron to 10 mm, preferably about 5 microns to 5 mm, and most preferably about 25 microns to 1 mm (with the preferred bond-line thickness for the bonded hardware and adhesive used thereat being established by the projections or standoffs of the mounting flanges). The adhesive may be a moisture-activated adhesive, a chemically activated adhesive, a heat or radiation or ultraviolet or microwave radiation activated adhesive or the like, and the door panel and hardware or frame portions may be exposed to the appropriate conditions or elements or radiation to cure the adhesive and bond the hardware and frame portions to the door panel, such as described in U.S. Pat. Nos. 6,298,606; 6,128,860; 5,966,874; 5,704,173; and 5,551,197; and 5,331,784, which are hereby incorporated herein by reference in their entireties.

Optionally, a temporary fixturing adhesive may also be provided, such as a hot-melt thermoplastic, which temporarily locates or fixtures the hardware and/or frame portion against the door panel or frit layer, while the bonding adhesive cures and forms the permanent primary bond. The temporary fixturing adhesive may secure or hold the hardware and/or frame portion to the door panel until the bonding process is complete and the bonding adhesive has cured and formed the permanent bond. Optionally, to improve and promote the bonding characteristics of the bonding adhesive, the glass surface (or frit layer if applicable), and/or the hardware and/or the frame portions, may be coated with an adhesion-promoting compound or primer, such as described in U.S. Pat. Nos. 7,360,338; 7,332,225; 6,871,450; 6,846,039; 6,319,344; 6,298,606; 6,128,860; 6,068,719; 5,966,874; 5,853,895; 5,704,173; and/or 5,551,197, which are hereby incorporated herein by reference in their entireties.

The frame portions and hardware thus may be readily adhered to or bonded to the glass door panel, such as via a bead of adhesive or the like. Desirably, the adhesive may comprise a transparent adhesive, such as a transparent or substantially transparent epoxy or acrylate or the like. Optionally, the adhesive may comprise a UV curable adhesive, such as a UV curable acrylate or epoxy or a UV curable optically matching adhesive, such as the optical adhesives of the types commercially available from Norland Products of Cranbury, N.J., or other suitable transparent or substantially transparent adhesive. Such UV curable adhesives provide rapid curing or bonding of the glass panel to the hardware element and/or perimeter frame after the element/frame is pressed against the attachment region or area or portion of the panel with the adhesive therebetween. Optionally, and desirably, the adhesive may be selected to be at least partially to substantially space filling so that any tolerances or gaps between the mounting flanges and the door panel are filled in or taken up by the adhesive. Optionally, beads, such as index matching beads, such as glass beads or fibers or polymeric beads or fibers or the like, may be provided so that the adhesive has an enhanced space filling function between the hardware and/or frame portions and the glass door panel.

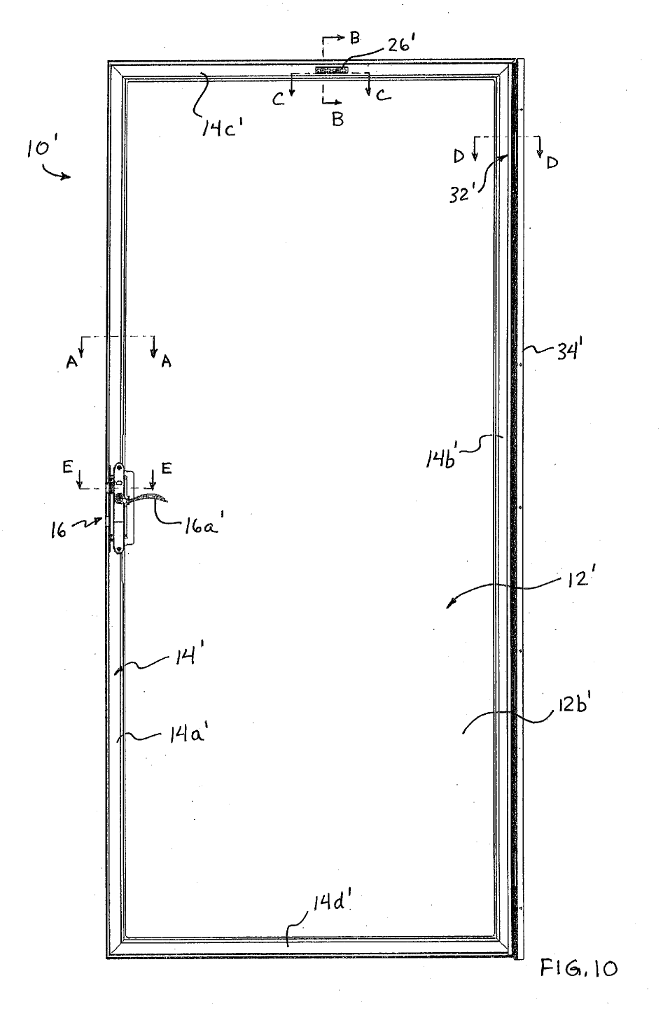

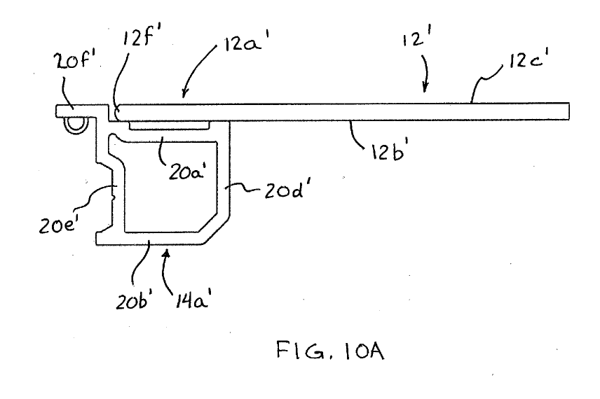

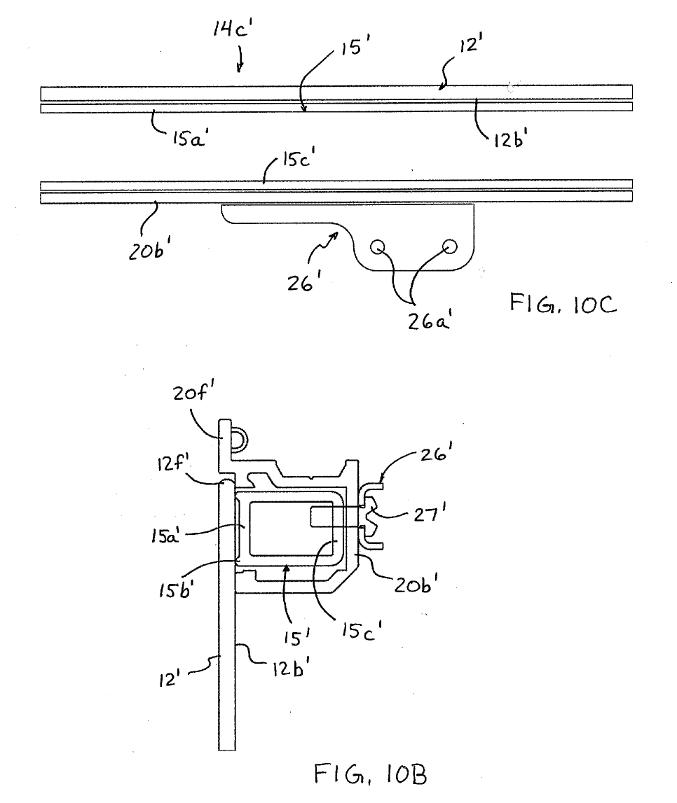

Optionally, and with reference to FIGS. 10 and 10A-B, a door assembly 10′ for a building or house or structure includes a substantially transparent door panel 12′ that has a perimeter frame portion 14′ bonded at least partially along the perimeter regions or edges 12a′ of door panel 12′, such as in a similar manner as described above. The perimeter frame 14′ is bonded or adhered to a surface of the door panel 12′ (such as to an interior surface 12b′ of the door panel when the door assembly is normally mounted to a structure or building) so that the frame does not extend around the perimeter edge of the door panel to encompass or cover a portion of the opposite surface of the door panel (such as an outer or exterior surface 12c′ of the door panel). Door assembly 10′ may be substantially similar to door assembly 10, discussed above, such that a detailed discussion of the door assemblies need not be repeated herein.

In the illustrated embodiment of FIGS. 10 and 10A-E, perimeter frame 14′ comprises a plastic or metallic outer frame member that extends along and around the perimeter of the door panel 12′ and includes elongated side portions 14a′, 14b′ and an upper portion 14c′ and a lower portion 14d′ joined together or abutting one another at the corners of the door panel and adhered or bonded to the interior surface of the door panel 12′ via a suitable adhesive, such as in a similar manner as described above. Each frame portion 14a′-d′ of perimeter frame 14′ may comprise a bonding surface or wall 20a′ (FIGS. 10A and 10E) and an opposite surface or wall 20b′ and side walls 20d′, 20e′ at opposite sides of the frame portion, with the outer side wall 20e′ having a trim element or strip 20f′ that is disposed along the perimeter edge 12f′ of door panel 12′ to provide a finished perimeter trim element around the perimeter edge of the door panel.

As shown in FIGS. 10B-D, the perimeter frame 14′ encompasses or encases an inner hollow metallic or plastic member or element 15′ that is disposed within and at least partially along perimeter frame portions 14b′ and 14c′. Inner member 15′ includes an attachment surface 15a′ with sidewardly or laterally disposed protrusions or legs 15b′ at or along the side regions of the inner member 15′ to space the attachment surface 15a′ from the door panel surface 12b′ a desired or appropriate amount for the adhesive to bond the inner member to the door panel surface. The inner members may comprise any suitable material, such as metal, such as aluminum or other suitable metal, and may be extruded or otherwise formed to the desired shape and length. The inner members 15′ extend partially along the respective perimeter regions and frame portions and are disposed at locations where a hardware element is attached to the door.

For example, an inner member 15′ (FIGS. 10B and 10C) may be disposed at an upper region of the door panel to provide support for attachment of a closure bracket 26′ at outer frame portion 14c′. The closure bracket 26′ may comprise any suitable bracket, such as a conventional bracket for attaching an end of a pneumatic or gas spring or cylinder to the door to control and dampen opening and closing of the door. In the illustrated embodiment, the closure bracket 26′ comprises a typical or conventional bracket that may be fastened (such as via a threaded fastener 27′ or the like) to the frame member 14c′ and inner member 15′ at a desired location along the upper frame member 14c′. For example, a self-tapping screw or the like may be used to screw through the outer wall 20b′ of frame member 14c′ and into the outer or closure bracket mounting wall 15c′ of the inner member 15′ or optionally a hole may be drilled through the frame member and inner member at the desired or appropriate locations for mounting the closure bracket. The end of the pneumatic or gas spring device or closure device may be attached at one of two locations at the bracket via a pin (not shown) extending through a selected set of apertures 26a′ of closure bracket 26′. The length of the inner member 15′ may be selected to be long enough to allow for a desired amount of flexibility in the mounting location of the closure bracket, depending on the type of closure device and/or door application. Optionally, and desirably, an inner mounting member 15′ may also be disposed within and partially along lower member 14d′ to provide a mounting location for a lower closure bracket for applications where a closure bracket may also or otherwise be disposed along the lower frame member of the door assembly (or to provide a mounting location for an upper closure bracket in applications where the door assembly is switched to have the hinges along the opposite side and the door panel is flipped over or rotated 180 degrees, such as a left hand opening door versus aright hand opening door or the like).

Likewise, a plurality of inner members 15′ may be disposed in spaced apart locations along the hinge side of the door panel and along or within the hinge side frame member 14b′ of perimeter frame 14′. The door assembly 10′ includes a plurality of hinge elements 32′ along the hinge side or perimeter edge region of the door panel. In the illustrated embodiment, the hinge elements 32′ comprise a cylindrical pin receiving portion 32a′ for pivotally attaching to a corresponding hinge element 34′ attached to the building or structure or door frame, such as via a pin or the like extending through aligned passageways of the respective pin receiving portions. The hinge elements 32′ may be mounted to the outer frame member 14b′ and the inner mounting members 15′, such as via a fastener or screw extending through the side wall 20d′ of the outer frame member 14b′ and into and through a side or hinge mounting wall 15d′ of the respective inner mounting member 15′. As shown in FIG. 10D, the building or structure or door frame may include a sealing element 36′ (such as a felt or rubber type seal or the like) that engages the outer side corner region along the outer frame member 14b′ when the door is closed (as shown in FIG. 10D) to limit air flow between the door and the door frame when the door is closed. Optionally, and desirably, a plurality of inner mounting members may also be disposed within and partially along the opposite side frame member 14a′ to provide mounting locations for hinge elements for applications where the door assembly is switched to have the hinges along the opposite side and the door panel is flipped over or rotated 180 degrees, such as a left hand opening door versus a right hand opening door or the like.

Door assembly 10′ also includes handle assembly 16′, which may be similar to handle assembly 16, described above. As can be seen in FIG. 10E, the handle assembly 16′ is established at perimeter frame member 14a′, and the frame member 14a′ may be adapted or configured to receive and/or support the handle assembly thereat. As also shown in FIG. 10E, a mounting element or trim element 30a′ may be disposed at outer surface 12c′ of door panel 12′, while an inner mounting element or trim element 30b′ may be disposed at the opposite or inner wall (not shown in FIG. 10E because it is cut away at the location of the cross section) of frame portion 14a′, with the handle portion 16a′ (FIG. 10) mounted at the cover or mounting element 30b′ and with the latch element or mechanism 16d′ extending through an opening or cutaway in the frame member 14a′. The shaft of the handle assembly (and optionally one or more fasteners securing the outer cover portion to the inner cover portion of the handle assembly) may extend through one or more apertures established through the door panel. The handle assembly 16′ may be similar to handle assembly 16, discussed above, such that a detailed discussion of the handle assemblies need not be repeated herein.

Thus, the full view storm door assembly of the present invention may consist of two sub-assemblies that may be assembled together to create the finished product. The first assembly may consist of a plastic co-extruded frame that is mitered in the corners and welded together to create the perimeter door frame. The co-extrusion may consist of a substantially rigid material that creates the structure of the door and that may have a flexible portion that serves as the seal for the door to the door frame of the building. The second assembly may consist of a piece of glass or glass door panel that has a ceramic paint applied around its perimeter regions. The glass door panel may also have one or more holes for the handle and latching mechanism. The glass door panel may also have two closure mounting brackets and two or more (such as four) hinge brackets mounted to or bonded to the inner surface of the glass door panel. These components may be mounted to the glass utilizing a two component urethane adhesive and associated primers, as discussed above. The plastic frame may be bonded to the glass door panel (and over and/or around the already bonded hardware or brackets). The combination of the two sub-assemblies may be made by bonding the glass panel sub-assembly to the frame sub-assembly by utilizing a one component urethane adhesive and associated primers.

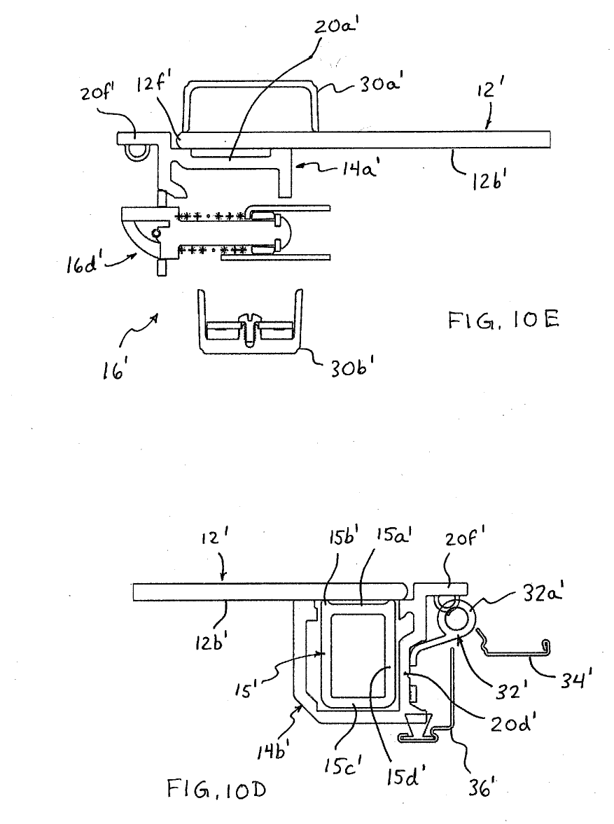

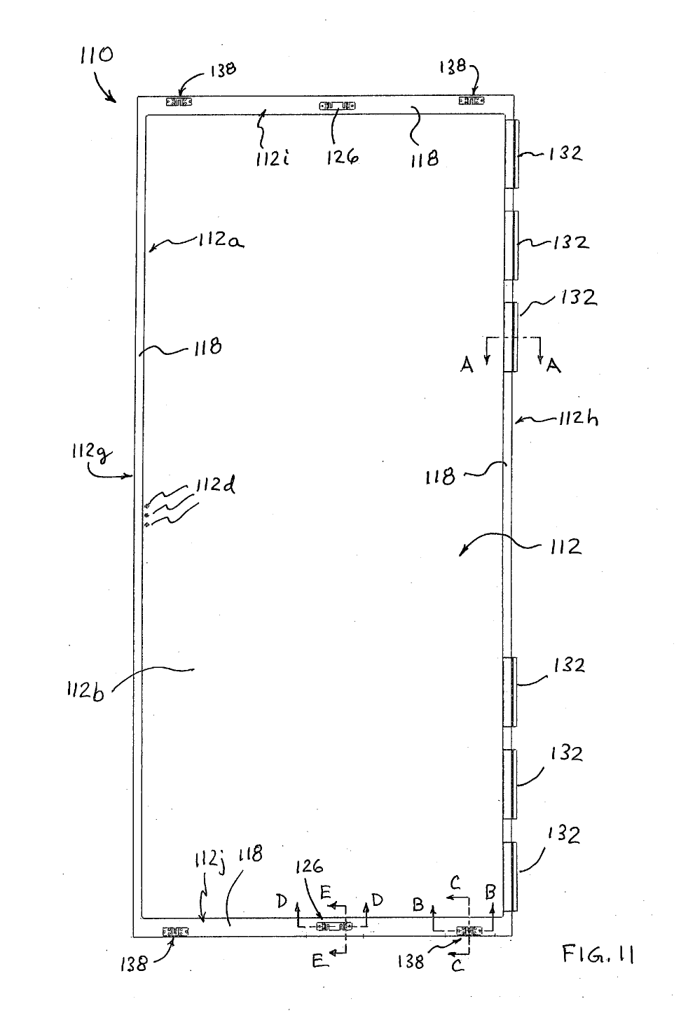

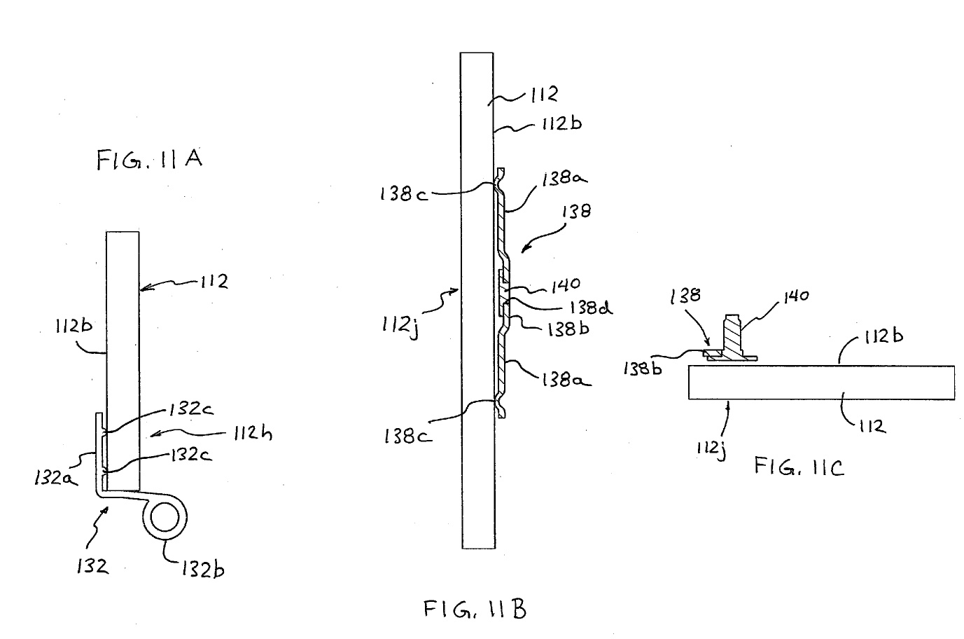

Optionally, the door assembly may be constructed without a perimeter frame portion about its perimeter edge regions to provide a full glass or frameless door panel, with the hardware elements (such as hinge elements and door closure brackets or elements and door handle elements and/or the like) adhesively bonded to a surface of the glass door panel. For example, and with reference to FIGS. 11 and 11A-E, a door assembly 110 for a building or house or structure includes a substantially transparent door panel 112 that has a closure bracket 126 and a plurality of hinge elements 132 adhesively bonded to the interior glass surface 112b of the door panel 112, which may have a darkened hiding coating or ceramic frit layer 118 (or other darkened or opaque hiding layer or coating) established or disposed along the perimeter regions 112a of the door panel to hide or conceal or render covert the presence of the bonded hardware elements 126, 132.

A handle assembly (not shown in FIGS. 11 and 11A-E) may be attached to the door panel 112, such as via adhesive bonding and/or portions of the handle assembly passing through apertures 112d established through the door panel (such as for securing an exterior portion of the door handle assembly relative to an interior portion of the door handle assembly with the door panel sandwiched therebetween) and at or near one of the side perimeter regions 112g of the door panel 112. The handle assembly of the door assembly may be similar to the handle assemblies of door assemblies 10, 10′, discussed above, such that a detailed discussion of the handle assemblies need not be repeated herein. For door assembly 110, the handle assembly may be a self-contained assembly with inner and outer portions that attach at the respective inner and outer surfaces of the door panel, such as via fasteners extending through respective ones of the apertures 112d of door panel 112, but may otherwise be similar in construction and/or operation as handle assemblies 16, 16′, discussed above.

In the illustrated embodiment, a plurality of hinge elements 132 are adhesively bonded along a side perimeter region 112h of door panel 112. As shown in FIG. 11A, hinge element 132 includes an attachment portion or flange 132a and a hinge pin receiving portion 132b. Attachment flange 132a comprises a generally planar portion with a plurality of projections or embossments 132e protruding therefrom to contact the inner glass surface 112b of door panel 112 and establish the desired or appropriate bondline thickness at the attachment or adhesive joint of the hinge element and door panel. The hinge element 132 may include at least three non-linearly aligned projections established inboard of the perimeter edges of the attachment flange 132a to provide a substantially uniform adhesive bondline thickness (such as, for example, a bondline thickness between 0.1 mm to 3 mm or on the order of 1 mm or thereabouts, depending on the adhesive selected) along and across the attachment flange and adhesive joint. As can be seen in FIG. 11, the hinge elements are distributed along the side perimeter region 112h of door panel 112 and are uniformly distributed relative to the upper end or region 112i and lower end or region 112j of door panel 112 to allow for flipping or rotating the door 180 degrees to adapt the door assembly for left or right opening doors. When the door panel is mounted to the building or door frame, one or more hinge pins or the like may be inserted through the passageways of hinge receiving portions 132b of hinge elements 132 and through corresponding and aligned passageways of hinge elements attached or mounted to the door frame, to pivotally or hingedly mount the door panel to the door frame.

In the illustrated embodiment, a closure bracket 126 is provided at both the upper end or region 112i and the lower end or region 112j of door panel 112 (and may be generally centrally located along the respective end region) to also facilitate flipping or rotating the door 180 degrees to adapt the door assembly for left or right opening doors. As shown in FIGS. 11, 11B, 11C and 14A-C, closure bracket 126 comprises a pair of mounting flanges 126a and a center portion 126b. Mounting flanges 126a include at least three projections or embossments 126c non-linearly arranged and disposed inboard of a perimeter edge of the flange to provide the desired or appropriate bondline thickness or thickness of the adhesive joint between the mounting flanges and the inner surface 112b of the door panel 112, such as in a similar manner as discussed above. The center portion 126b is raised or spaced from the door panel when the closure bracket 126 is bonded to the door panel 112 and includes a pair of slots 126d established partially across the center portion 126b. The slots 126d are configured to receive pins or fasteners (not shown) to attach the appropriate closure attachment or bracket (for the particular closure mechanism implemented with the door assembly) to the closure bracket 126. The closure attachment thus may be attached to the closure bracket (such as the upper closure bracket) when the door is installed at the building or door frame (and the closure attachment may provide for side-to-side or lateral positioning or adjustment to adapt the closure attachment for the particular application of the door assembly). In applications where only one closure bracket is needed, the other closure bracket (such as the lower closure bracket) is hidden from view by the opaque perimeter coating or layer 118 established around the perimeter region of the door panel and is left in its unused state.

In the illustrated embodiment, door assembly 110 also includes a pair of mounting brackets or expander bracket 138 adhesively bonded at or near the sides of the door panel 112 and at the lower and upper perimeter regions of the door panel 112. Mounting brackets 138 are provided for attaching a trim plate or lower plate or extension (such as an extruded aluminum panel with a felt or rubber seal element or sweep element along its lower edge) at the lower end or region 112j of door panel 112, so as to adjust the overall height or size of the door panel to the size of the door opening and to provide a lower seal that abuts against the lower portion of the door frame or opening to limit airflow under the door panel when the door panel is closed. The mounting brackets are provided at both the upper and lower regions 112i, 112j so that the door may be flipped or rotated to accommodate different types of openings, such as a left hand opening door or a right hand opening door.

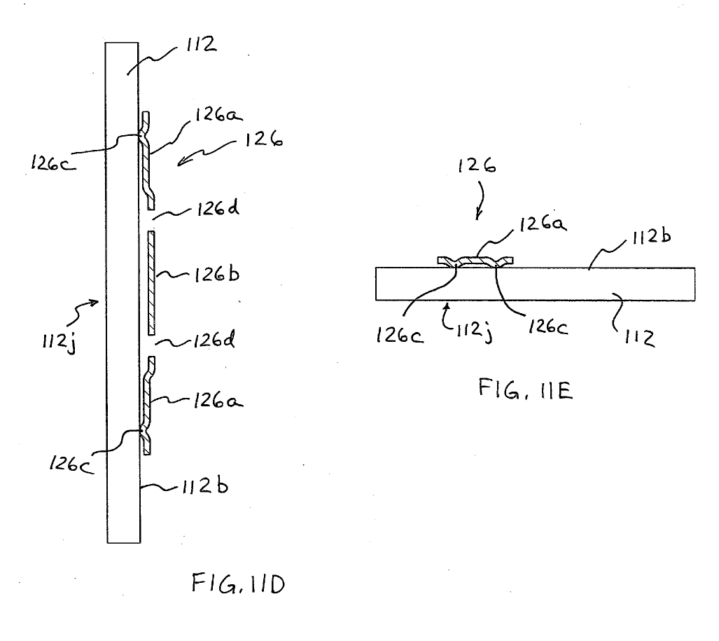

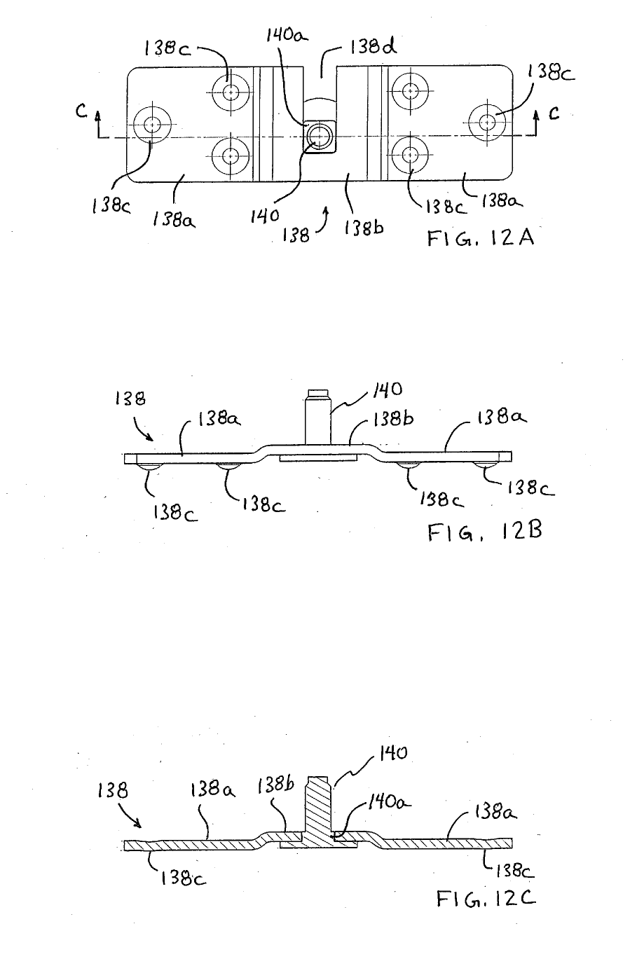

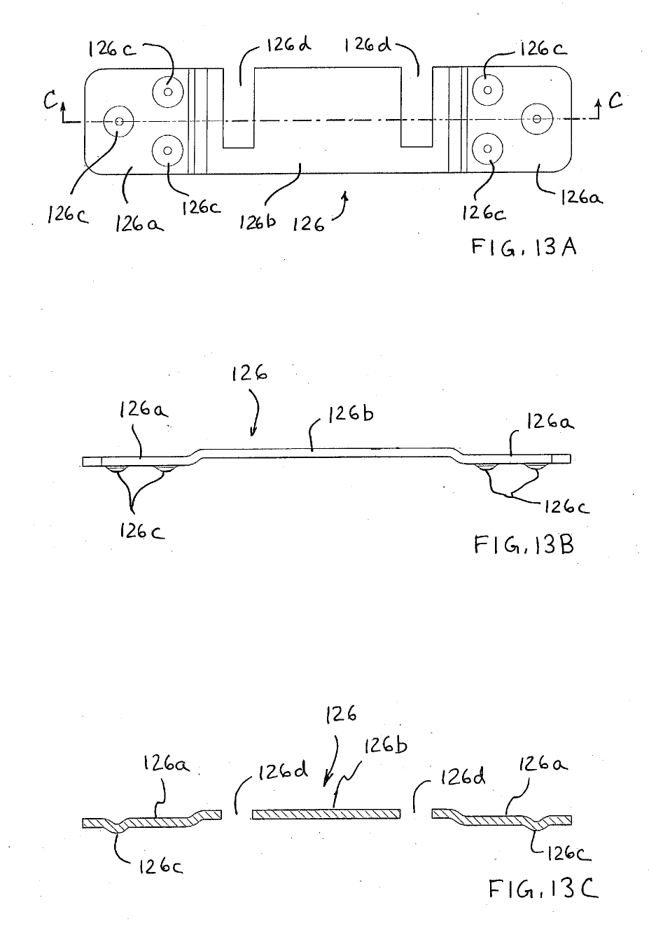

As shown in FIGS. 11, 11B, 11C and 12A-C, mounting brackets 138 include a pair of attachment or bonding flanges 138a and a center portion 138b. Mounting flanges 138a include at least three projections or embossments 138c non-linearly arranged and disposed inboard of a perimeter edge of the flange to provide the desired or appropriate bondline thickness or thickness of the adhesive joint between the mounting flanges and the inner surface 112b of the door panel 112, such as in a similar manner as discussed above. The center portion 138b is raised or spaced from the door panel when the mounting bracket 138 is bonded to the door panel 112 and includes a slot 138d established partially across the center portion 138b. The slot 138d is configured to receive a pin or fastener 140 to attach the trim plate to each of the mounting brackets 138 (as can be seen in FIG. 12A, the pin 140 may include a non-circular base portion 140a to non-rotatably receive or hold the pin within the slot 138d to assist in fastening or securing the trim plate to the mounting brackets). The trim plate thus may be attached to the mounting brackets along the lower perimeter region of the door panel and may be adjusted to the appropriate degree of extension below the lower perimeter edge of the door panel when the door is installed at the building or door frame. The mounting brackets at the upper perimeter region of the door panel may not be used and remain hidden from view by the opaque perimeter coating or layer 118 established around the perimeter region of the door panel when left in their unused state.

Therefore, the full view storm door assembly of the present invention may consist of a glass door panel with hardware elements bonded thereto to provide a single product or assembled panel for mounting to a building or door frame. The glass door panel has a ceramic paint or opaque coating applied around its perimeter regions and may have one or more holes established therethrough for the handle and latching mechanism. The glass door panel may also have two closure mounting brackets and two or more (such as four or six) hinge brackets adhesively bonded to the inner surface of the glass door panel. A lower trim panel may be mounted to the glass door panel at one or more mounting brackets that are adhesively bonded to the glass door panel, and the height of the lower trim panel may be adjusted to adapt the overall height of the door assembly for the door frame or door opening at which the door assembly is installed. The bonded hardware components may be mounted to or adhered to the glass utilizing a two component urethane adhesive and associated primers, such as discussed above. The glass panel thus may have the brackets and hinge elements bonded thereto and may be shipped to the installation site as a single unit, whereby the trim panel and/or door closure element or device or bracket may be attached to the bonded brackets at the door installation site or building and after the door panel is hingedly mounted at the door frame.

Changes and modifications to the specifically described embodiments can be carried out without departing from the principles of the present invention, which is intended to be limited only by the scope of the appended claims as interpreted according to the principles of patent law.

The embodiments of the invention in which an exclusive property or privilege is claimed are defined as follows:

1. A door assembly for use in a building, said door assembly comprising:
a door panel comprising a glass material, said door panel having an outer surface and an inner surface and a perimeter region; and
a perimeter frame portion bonded via a first layer of cured adhesive to said inner surface of said door panel and along said perimeter region of said door panel, said first layer of cured adhesive bonding said perimeter frame portion to said inner surface of said glass door panel without exposure of said bonded perimeter frame portion on said outer surface of said glass door panel.

2. The door assembly of claim 1, wherein said perimeter frame portion comprises a polymeric material.

3. The door assembly of claim 1, wherein said first layer of cured adhesive comprises a single component urethane adhesive.

4. The door assembly of claim 1 further comprising at least one metallic bracket bonded to said inner surface of said glass door panel via a second layer of cured adhesive, wherein said bracket is disposed at said perimeter frame.

5. The door assembly of claim 4, wherein said bracket is configured for mounting to a hinge element to mount said door assembly at the building.

6. The door assembly of claim 4, wherein said bracket is configured for mounting to a closure bracket for mounting to a door closure element when said door assembly is mounted at the building.

7. The door assembly of claim 4, wherein said second layer of cured adhesive comprises a two component urethane adhesive.

8. The door assembly of claim 4, wherein said at least one metallic bracket includes a plurality of protrusions extending from a generally planar portion of said at least one metallic bracket to set a thickness of said second layer of cured adhesive between said generally planar portion of said at least one metallic bracket and said inner surface of said glass door panel.

9. The door assembly of claim 4, wherein said perimeter frame portion at least partially encompasses said at least one metallic bracket.

10. The door assembly of claim 1 further comprising at least one metallic hardware element, wherein said at least one metallic hardware element comprises at least one of (a) metallic hinge bracket bonded to said inner surface of said glass door panel via a second layer of cured adhesive, and wherein said hinge bracket is disposed at said perimeter frame and configured for mounting to a hinge element to mount said door assembly at the building, and (b) at least one metallic closure bracket bonded to said inner surface of said glass door panel via a second layer of cured adhesive, and wherein said closure bracket is disposed at said perimeter frame and is configured for mounting to a door closure element when said door assembly is mounted at the building.

11. The door assembly of claim 10, wherein said second layer of cured adhesive comprises a two component urethane adhesive.

12. The door assembly of claim 10, wherein said at least one metallic hardware element includes a plurality of protrusions extending from a generally planar portion of said at least one metallic hardware element to set a thickness of said second layer of cured adhesive between said generally planar portion of said at least one metallic hardware element and said inner surface of said glass door panel.

13. The door assembly of claim 1 further comprising a door handle assembly, at least a portion of said door handle assembly protruding through an aperture formed in said glass door panel and an aperture formed through said perimeter frame portion.

14. A door assembly for use in a building, said door assembly comprising:
a door panel comprising a glass material, said door panel having an outer surface and an inner surface and a perimeter region;
a perimeter frame portion comprising a polymeric material, said perimeter frame portion bonded via a first layer of cured adhesive to said inner surface of said door panel and along said perimeter region of said door panel, said first layer of cured adhesive bonding said perimeter frame portion to said inner surface of said glass door panel without exposure of said bonded perimeter frame portion on said outer surface of said glass door panel;
at least one metallic hardware element bonded to said inner surface of said glass door panel via a second layer of cured adhesive, wherein said hardware element is disposed at said perimeter frame and is configured for mounting to a support element at the building; and
a door handle assembly, at least a portion of said door handle assembly protruding through an aperture formed in said glass door panel and an aperture formed through said perimeter frame portion.

15. The door assembly of claim 14, wherein said first layer of cured adhesive comprises a single component urethane adhesive.

16. The door assembly of claim 15, wherein said second layer of cured adhesive comprises a two component urethane adhesive.

17. The door assembly of claim 16, wherein said at least one metallic hardware element includes a plurality of protrusions extending from generally planar portion of said at least one metallic hardware element to set a thickness of said layer of cured adhesive between said generally planar portion of said at least one metallic hardware element and said inner surface of said glass door panel.

18. The door assembly of claim 14, wherein said perimeter frame portion at least partially encompasses said at least one metallic hardware element.

19. The door assembly of claim 18, wherein said at least one hardware element is configured for mounting to at least one of (a) a hinge element to mount said door assembly at the building, (b) a closure bracket for mounting to a door closure element when said door assembly is mounted at the building and (c) a trim plate for adjusting an overall height of said door assembly to adapt said door assembly to a door opening size when said door assembly is mounted at the building.

20. The door assembly of claim 14, wherein said at least one hardware element comprises at least one hinge bracket configured for mounting to a hinge element at the door frame of the building to which said door assembly is mounted.

21. The door assembly of claim 20, wherein said at least one hardware element further comprises at least one closure bracket configured for mounting to a door closure element when said door assembly is mounted at the building.

22. A door assembly for use in a building, said door assembly comprising:
a glass door panel comprising a glass material, said door panel having an outer surface and an inner surface and a perimeter region, and wherein an opaque coating is established at said perimeter region of said door panel;
at least one metallic hinge element bonded to said inner surface of said glass door panel via a layer of cured adhesive, wherein said hinge element is disposed at a first side perimeter region of said door panel and at said opaque coating and is configured for mounting to a support element at the building;
wherein said layer of cured adhesive bonds said at least one metallic hinge element to said inner surface of said glass door panel without exposure of said bonded hinge element on said outer surface of said glass door panel; and
wherein said glass door panel includes at least one aperture formed therethrough at a second side perimeter region of said door panel for attachment of a door handle assembly, and wherein said second side perimeter region is generally opposite said first side perimeter region.

23. The door assembly of claim 22, wherein said layer of cured adhesive comprises a two component urethane adhesive.

24. The door assembly of claim 22, wherein said at least one metallic hinge element includes a plurality of protrusions extending from a generally planar portion of said at least one metallic hinge element to set a thickness of said layer of cured adhesive between said generally planar portion of said at least one metallic hinge element and said inner surface of said glass door panel.

25. The door assembly of claim 22 further comprising at least one metallic hardware element bonded to said inner surface of said glass door panel via another layer of cured adhesive, wherein said at least one metallic hardware element is disposed at an upper or lower perimeter region of said door panel and at said opaque coating, and wherein said other layer of cured adhesive bonds said at least one metallic hardware element to said inner surface of said glass door panel without exposure of said bonded hardware element on said outer surface of said glass door panel.

26. The door assembly of claim 25, wherein said at least one hardware element is configured for mounting to at least one of (a) a closure bracket for mounting to a door closure element when said door assembly is mounted at the building and (b) a trim plate for adjusting an overall height of said door assembly to adapt said door assembly to a door opening size when said door assembly is mounted at the building.

27. The door assembly of claim 22 further comprising a perimeter frame portion bonded to said inner surface of said door panel and along said perimeter region of said door panel, and wherein said perimeter frame portion at least partially encompasses a mounting portion of said at least one metallic hinge element.

28. The door assembly of claim 27, wherein said perimeter frame portion comprises a polymeric material and is bonded via a second layer of cured adhesive to said inner surface of said door panel, said second layer of cured adhesive bonding said perimeter frame portion to said inner surface of said glass door panel without exposure of said bonded perimeter frame portion on said outer surface of said glass door panel.
